(19) United States
(12) Patent Application Publication
(10) Pub. No.: US 2026/0140714 A1
(43) Pub. Date: May 21, 2026

(54) METHOD FOR GENERATING A CONTROL PROGRAM FOR AN AUTOMATION SYSTEM AND DEVELOPMENT ENVIRONMENT

(71) Applicant: Beckhoff Automation GmbH, Verl (DE)

(72) Inventor: Ralf Dreesen, Rietberg (DE)

(21) Appl. No.: 19/447,642

(22) Filed: Jan. 13, 2026

Related U.S. Application Data
(63) Continuation of application No. PCT/EP2024/076290, filed on Sep. 19, 2024.

(30) Foreign Application Priority Data
Sep. 22, 2023 (DE) 10 2023 125 802.8

(51) Int. Cl. G06F 8/34; G05B 19/042; G06F 8/71

(52) U.S. Cl. CPC G06F 8/34; G05B 19/0426; G06F 8/71

(57) ABSTRACT

A computer-implemented method for generating a control program for an automation system comprises translating a graphical diagram of a graphical programming language into a textual intermediate representation of the graphical diagram with the aid of a translation module of a development environment in a first translating step. The first translating step comprises carrying out a line-by-line translation in a line translating step; and storing the textual intermediate representation in a representation file in a storing step. A development environment is provided for carrying out the method.

### CROSS REFERENCE TO RELATED APPLICATIONS

This patent application is a continuation of International Patent Application No. PCT/EP2024/076290, filed Sep. 19, 2024, entitled “Method for Generating a Control Program for an Automation System, and Development Environment,” which claims the priority of German Patent Application DE 10 2023 125 802.8, filed Sep. 22, 2023, entitled “Verfahren zum Erzeugen eines Steuerprogramms für ein Automatisierungssystem und Entwicklungsumgebung,” the disclosures of each of which are hereby incorporated by reference herein, in the entirety and for all purposes.

### TECHNICAL FIELD

The application relates to a method for generating a control program for an automation system and to a development environment.

### BACKGROUND

Graphical programming languages are known from the prior art for the graphical programming of programmable logic controllers (PLCs) in automation technology. Three graphical programming languages are defined in the IEC 61131-3 standard: ladder diagram, functional block diagram, and sequence diagram. The aforementioned graphical programming languages allow for user-friendly graphical programming in which graphical diagrams may be generated graphically as graphical representations for control programs to be generated for programmable logic controllers by adding and/or removing predefined graphical program objects.

For graphical programming languages, conversions of the graphical diagrams into intermediate representations are known from the prior art. However, the conversions known from the prior art are not compatible with version management systems. Version management systems provide helpful support for the programming process. The versions of the code to be programmed that are created during the programming process may be managed in version management systems. Version management systems thus allow for the programming process to be tracked by comparing different versions of the program code that has been created. Moreover, managing the program code in version management systems makes it possible to restore older versions of the program code.

### SUMMARY

The application provides an improved method for generating a control program for an automation system and an improved development environment.

### EXAMPLES

According to an aspect of the application, a computer-implemented method for generating a control program for an automation system is provided, comprising:
translating a graphical diagram of a graphical programming language into a textual intermediate representation of the graphical diagram with the aid of a translation module of a development environment in a first translating step, wherein the graphical diagram graphically represents at least a part of a control program for an automation system according to the graphical programming language, wherein the textual intermediate representation provides a textual description of the graphical diagram, and wherein the first translating step comprises:
carrying out a line-by-line translation in a line translating step, wherein in the line-by-line translation, graphical program objects of the graphical diagram are each assigned a textual program object in the form of at least one textual line of the textual intermediate representation, wherein the graphical program objects are partial elements of the graphical diagram and represent program objects of the control program, and wherein the textual lines of the textual program objects provide unique descriptions of the respective graphical program objects; and
storing the textual intermediate representation in a display file in a storing step.

This achieves the technical advantage of providing an improved method for programming a control program for an automation system. The method according to the application allows for graphical programming of the control program with the aid of a graphical programming language known from the prior art. Furthermore, the method according to the application makes it possible to track programming progress during the graphical programming process of the control program with the aid of a version controller. For this purpose, a graphical diagram programmed in accordance with a selected graphical programming language is first translated into a textual intermediate representation.

The translation is carried out by a translation module of a development environment used to program the control program. The graphical diagram represents a graphical representation of at least part of the control program to be programmed in accordance with the graphical programming languages known from the prior art. The graphical diagram comprises at least one graphical program object. The graphical program object is accordingly a graphical representation of at least one program object of the control program to be programmed.

The translation module translates the graphical diagram into the aforementioned textual intermediate representation. The textual intermediate representation is a textual representation or description of the graphical diagram. The textual intermediate representation comprises at least one textual program object corresponding to the graphical diagram. The textual program object is a textual representation or description of the graphical program object of the graphical diagram.

According to the application, the graphical diagram is translated into the textual intermediate representation by carrying out a line-by-line translation of the graphical diagram. For this purpose, the graphical program objects of the graphical diagram are converted into corresponding textual program objects of the textual intermediate representation. The textual program objects are represented by at least one textual line of the line-by-line structured textual intermediate representation. The textual line completely describes each textual program object and the graphical program object assigned to the textual program object.

The textual intermediate representation created in this manner is then saved in a representation file. The representation file may be read by a version management system known from the prior art. The information of the line-by-line textual intermediate representation may be captured by the version management system, allowing for the version management system to track the programming progress of the control program based on the created textual intermediate representations of the graphical diagrams.

The version management system is able to compare the textual program objects written in the form of textual lines of different textual intermediate representations of different graphical diagrams, which are based, for example, on different versions of the programmed control program, in order to determine differences within the different textual intermediate representations. The aforementioned programming progress of the control program may be determined from the differences between the various textual intermediate representations.

By translating the graphical diagrams programmed using the graphical programming language line by line into textual intermediate representations, all functions of the version management system known in the prior art may also be used for program code created using a graphical programming language. This simplifies the programming process and facilitates the programming of control programs in graphical programming languages.

According to an embodiment, the method further comprises:
displaying the graphical diagram in a graphical editor unit of the development environment in a first displaying step; and/or
displaying the textual intermediate representation of the graphical diagram in a textual editor unit of the development environment in a second displaying step; and
generating the control program based on the textual intermediate representation of the graphical diagram of the graphical programming language and/or based on the graphical diagram in a generating step.

This achieves the technical advantage that, by displaying the graphical diagram in the graphical editor unit of the development environment or by displaying the textual intermediate representation in the textual editor unit of the development environment, the programmed program code may be made available to the user at any time in both graphical and textual form. The user is thus able to track the created program code of the control program both in the graphical editor unit in the form of the correspondingly created graphical diagrams and in the textual editor unit in the form of the textual intermediate representation, or to check it for correctness.

The control program may then be generated based on both the graphical diagram and the textual intermediate representation. The textual intermediate representation thus does not serve exclusively as a textual form of the graphical diagram, which allows for the use of version management systems known from the prior art. In addition, the graphical intermediate representation also serves as an intermediate representation of the graphical diagrams required for a compilation process to generate the control program. An additional intermediate representation, on the basis of which the compilation of the graphical diagrams is allowed for, is thus omitted. This leads to a leaner programming process.

According to an embodiment, the method further comprises:
receiving textual difference information from a version management system via the development environment in a receiving step, wherein the difference information describes a difference between a first version of the textual intermediate representation and a second version of the textual intermediate representation, wherein the first version and the second version of the textual intermediate representation are respective representations of a first version and of a second version of the graphical diagram, wherein the first and second versions of the graphical diagram were created in a programming process based on each other or on a common base diagram, and wherein the textual difference information defines at least one textual program object that is contained only in one of the two versions of the textual intermediate representation; and
displaying the at least one textual program object of the textual difference information in the textual editor unit of the development environment in a textual displaying step; and/or
translating the textual difference information into graphical difference information by translating the at least one textual program object into a corresponding graphical program object in a difference translating step; and
displaying the at least one graphical program object of the graphical difference information in a graphical editor unit of the development environment in a graphical displaying step.

This achieves the technical advantage that a difference between at least two versions of the textual intermediate representation may be displayed to the user in the development environment. For this purpose, difference information from the version management system used is taken into account. As is known from the prior art for version management systems, the difference information comprises information relating to the differences between two versions of the textual intermediate representation managed by the version management system. In this context, the different versions of the textual intermediate representation represent different versions of the control program programmed with the graphical programming language. In this context, the different versions have been created at different times and/or by different authors during the graphical programming process.

In the embodiment shown, the difference information of the version management system is received and read in by the development environment. The difference information comprises information relating to at least one textual program object that is contained exclusively in one of the two versions.

According to the application, changes in the graphical diagram are carried out by adding or deleting graphical program objects. Correspondingly, changes in corresponding textual intermediate representations are carried out by adding or removing textual program objects. Differences between different versions of textual intermediate representations are thus provided by program objects that have been added or deleted in one intermediate representation with respect to a version of the intermediate representation in the other intermediate representation.

The correspondingly received textual difference information is then displayed in the textual editor unit of the development environment. For this purpose, the corresponding added or deleted textual program objects may be displayed in one of the versions of the textual intermediate representation as corresponding added or deleted textual program objects.

As an alternative or in addition, the textual difference information may be translated into corresponding graphical difference information. For this purpose, the aforementioned textual program objects of the textual difference information that are contained exclusively in one of the two versions of the textual intermediate representation are translated into corresponding graphical program objects. The translation is carried out by the translation module in the same way as the translation processes described above.

The corresponding translated graphical program objects of the graphical difference information may then be displayed in the graphical editor unit of the development environment. For this purpose, the corresponding graphical program objects of the graphical difference information may be integrated into one of the two versions of the graphical diagrams and displayed as correspondingly deleted or added graphical program objects.

By using the difference information of the version management system and displaying the corresponding difference information in textual or graphical form, the user may immediately see the difference between two versions of the control program in the form of the difference between two versions of the corresponding textual intermediate representation. The user is thus immediately able to see the programming progress between the two versions of the control program in both graphical and textual form. This in turn facilitates the programming process.

If only a few graphical program objects are changed between two versions of the graphical diagram, only a few lines, i.e., textual program objects, are changed between the respective versions of the corresponding textual intermediate representations. In this case, the corresponding difference information of the version management system also comprises only a few changed lines.

The difference information therefore takes up only a small amount of storage space. The line-by-line translation of the graphical diagrams into textual intermediate representations thus reduces the storage space required for a version management system.

Furthermore, the reduced-size difference information may be transferred more quickly via a medium such as the Internet.

By translating the graphical diagram line by line into a textual intermediate representation, the difference information may be transferred, recorded, and displayed to a user in text form.

The textual difference information shows to a developer in a compact and immediate manner which graphical elements have been affected.

The difference information may also be displayed in the graphical language. This display is easier for a developer to understand and is familiar to them.

Meta information from imports, such as the author and the date of creation, may be automatically displayed in the graphical representation or the graphical diagram. This information does not need to be added to the program as explicit documentation. This reduces the effort involved and ensures consistency with the information in the version controller.

The graphical diagram may be displayed in the user interface of a machine to be controlled. The sequence control of the machine to be controlled may be displayed in an SFC language.

In the user interface, the machine operator may be made aware of changes in the control program by highlighting and/or annotation.

According to an embodiment, the second version of the graphical diagram comprises a later creation date than the first version of the graphical diagram, wherein at least one textual program object is added to or removed from the corresponding second version of the textual intermediate representation compared to the first version of the textual intermediate representation, and wherein, in the textual difference information, the at least one textual program object is identified as a textual program object added to or deleted from the first version of the textual intermediate representation.

This achieves the technical advantage that the difference between two different versions of the control program may be immediately displayed to the user. For this purpose, the textual program objects of the textual difference information are marked in the textual intermediate representation as added or deleted textual program objects. Similarly, the graphical program objects of the graphical difference information are marked in the graphical diagram as added or deleted graphical program objects.

By marking the program objects as added or deleted textual or graphical program objects, the user may not only see that two versions of the control program are different, but the actual differences in the form of the added or deleted program objects may also be seen immediately thanks to the corresponding marking.

According to an embodiment, the textual displaying step and/or the graphical displaying step comprise:
marking the textual program object of the textual difference information and/or the graphical program object of the graphical difference information as an added textual program object or an added graphical program object or as a deleted textual program object or as a deleted graphical program object in a characterizing step.

This achieves the technical advantage that, by marking the added or deleted program objects, the difference between two versions of the control program may be clearly displayed both in graphic and in textual form.

According to an embodiment, a textual program object changed from the first version to the second version of the textual intermediate representation is represented in the difference information as a pair consisting of a deleted textual program object of the first version of the textual intermediate representation and an added textual program object of the second version of the textual intermediate representation, wherein the deleted textual program object represents an original version of the changed textual program object and the added textual program object represents a changed version of the changed textual program object.

This achieves the technical advantage of allowing for a clear representation of program objects that have been changed between two versions of the textual intermediate representation or the graphical diagram. For this purpose, textual program objects that have been changed between two versions of the textual intermediate representation are represented as a pair of textual lines, particularly in the textual intermediate representation. The pair of textual lines comprises a textual line deleted in a first version of the textual intermediate representation and a textual line added in the second version of the textual intermediate representation.

Both lines describe the same textual program object or represent a textual representation of the same graphical program object. The difference between the two textual lines relates primarily to the actual description of the respective graphical program object. However, both textual lines continue to represent the same graphical program object.

By deleting one textual line in the first version of the textual intermediate representation and adding the other textual line in the second version of the textual intermediate representation, wherein the two lines refer to the same graphical program object, a change in the textual description of the graphical program object and thus a change in the textual program object may be indicated. Such a representation of the change to a textual program object in the form of a pair of a deleted textual line and an added textual line thus allow for a clear representation of changed textual program objects. The user may thus see clearly and at a glance which textual program objects have been changed in the different versions of the textual intermediate representation.

According to an embodiment, the deleted graphical program object corresponding to the deleted textual program object and/or the added graphical program object corresponding to the added textual program object and/or a modified graphical program object corresponding to the modified textual program object are displayed in the graphical diagram as a deleted graphical program object and/or as an added graphical program object and/or as a modified graphical program object or as an added graphical program object and/or as a modified graphical program object.

This achieves the technical advantage that by displaying the added or deleted textual program objects in the current version of the textual intermediate representation or by displaying the corresponding deleted or added graphical program objects in the corresponding graphical diagram, the user may see the changes between two versions of the textual intermediate representation and the corresponding changes between two versions of the associated graphical diagrams at a glance. The corresponding deleted or added textual and graphical program objects may, for example, be color-coded so that the deleted or added textual and graphical program objects may be recognized at a glance.

According to an embodiment, the method further comprises:
receiving textual conflict information from the version management system and carrying out a conflict check between the first version of the textual intermediate representation and of the second version of the textual intermediate representation in a conflict checking step, wherein the textual conflict information comprises textual program objects that are assigned to the first version of the textual intermediate representation, and comprising textual program objects associated with the second version of the textual intermediate representation; and
determining a conflict in a conflict determining step if at least one textual program object associated with the first version of the textual intermediate representation and one textual program object associated with the second version of the textual intermediate representation are detected that have an identical identity and are modified relative to each other.

This achieves the technical advantage that conflicts between two existing versions of the textual intermediate representation or the control program may be identified by taking into account textual conflict information from the version management system. The textual conflict information comprises information relating to textual program objects that are assigned to both the first version of the textual intermediate representation and the second version of the textual intermediate representation and that have been changed relative to each other.

As described above, changed textual program objects are represented by a pair of textual lines, wherein a first line is a line deleted from the first version of the textual intermediate representation, while a second line of the pair is a textual line inserted into the second version of the textual intermediate representation. Both lines refer to the same graphical program object. Consequently, both textual lines contain the same identity of the respective graphical program object, but are different or changed relative to each other.

Such conflicts may occur when a plurality of developers independently develops the same program code and the two versions of the textual intermediate representation have therefore been created by different developers and are based on a common version of the textual intermediate representation.

By taking the conflict information into account, a conflict between two existing versions of the textual intermediate representation may be determined by carrying out a conflict resolution if the conflict information comprises a first textual line that is assigned to the first version of the textual intermediate representation and includes a second textual line that is assigned to the second version of the textual intermediate representation, and if the two lines have the same identity, thus refer to the same program object, and are modified or different relative to each other. By taking the conflict information into account, conflicts between the two versions of the textual intermediate representation may thus be determined and resolved accordingly.

According to an embodiment, the conflict detecting step comprises:
translating the textual conflict information into graphical conflict information by the translation module in a conflict translating step, wherein the graphical conflict information comprises graphical program objects corresponding to the textual program objects of the textual conflict information; and
resolving the conflict by deleting the at least one graphical program object that corresponds to a textual program object that is assigned to the first version of the textual intermediate representation and that has an identical identity to another graphical program object that corresponds to a textual program object that is assigned to the second version of the textual intermediate representation.

This achieves the technical advantage that translating the textual conflict information into graphical conflict information allows the conflict between the two versions of the textual intermediate representation or between the two versions of the corresponding graphical diagrams to be displayed or resolved in the graphical diagrams. For this purpose, the conflict is resolved by deleting at least one of the two graphical program objects corresponding to the two textual program objects of the textual conflict information. By deleting one of the two graphical program objects, the conflict is resolved in such a way that only one of the two graphical program objects remains.

A conflict between at least two versions of the control program may be displayed textually and graphically. This graphical representation is familiar to developers and facilitates comparison and conflict resolution.

The graphical representation allows for automatic conflict resolution. This reduces the amount of work involved and the likelihood of incorrect resolution.

Let there be two identical machines controlled by the same graphical control program. By making changes in different parts of the control program, a first performance feature may be added to the first machine and a second performance feature may be added to the second machine independently of each other. The control programs of the two machines may then be automatically merged into a single control program that includes both performance features. This control program may be transferred to the two machines and/or to a third machine. The control of the two or three machines may thus be aligned and the control of the machines includes both performance features.

According to an embodiment, the method further comprises:
receiving graphical input commands from a user of the development environment by a graphical editor unit of the development environment in a graphical programming step, wherein the graphical input commands comprise programming commands for adding and/or removing graphical program objects of the graphical diagram; and/or
reading in a program file in a reading step, wherein the program file describes the graphical diagram and the graphical program objects of the graphical diagram in a textual description;
translating the textual description into the graphical diagram by the translation module in a second translating step.

This achieves the technical advantage that the method according to the application allows graphical programming of the control program to be taken into account.

An alternative describes the case in which the user creates or modifies the graphical diagram by entering corresponding input commands in the graphical editor unit, for example by adding or removing corresponding graphical program objects. This graphical diagram, which has been modified or newly generated by the graphical programming process, may then be translated into a corresponding textual intermediate representation in accordance with the above-described embodiments and displayed to the user in the textual editor unit.

Subsequently, the control program to be generated is created based on the graphical diagram created in the graphical programming process and/or based on the corresponding textual intermediate representation. The user may thus create the control program by carrying out a graphical programming process and generating a corresponding graphical diagram in accordance with the rules of the selected graphical programming language.

In a further alternative, the graphical diagram may be generated based on a pre-stored program file. This describes the case in which a graphical diagram already generated in an earlier graphical programming process which is stored in textual form in the pre-stored program file, is read in by the development environment and displayed to the user in the form of the graphical diagram in the graphical editor unit and in the form of the textual intermediate representation generated by the translation process and written in a form readable by the user in the corresponding textual editor unit. Based on this, the user may carry out a further graphical programming operation in accordance with the embodiment described above and modify the graphical editor unit accordingly by adding or removing graphical program objects in accordance with the graphical input commands described.

According to an embodiment, the method further comprises:
receiving textual input commands from the user by the textual editor unit of the development environment in a textual programming step, wherein the textual input commands add or remove textual program objects as textual representations of corresponding graphical program objects of the graphical diagram to or from the textual intermediate representation of the graphical diagram;
generating a modified textual intermediate representation based on the textual input commands and the textual intermediate representation of the graphical diagram in a second generating step;
translating the modified textual intermediate representation into a correspondingly modified graphical diagram and/or translating the textual program objects of the textual input commands into corresponding graphical program objects by the translation module in a third translating step;
displaying the modified graphical diagram instead of the graphical diagram and/or displaying the graphical program objects translated from the textual program objects of the textual input commands in the graphical diagram as a modified graphical diagram in the graphical editor unit in a third displaying step;
generating the control program based on the modified textual intermediate representation of the modified graphical diagram and/or based on the modified graphical diagram in the generating step; and
displaying the modified textual intermediate representation of the modified graphical diagram in the textual editor unit in a fourth displaying step.

This achieves the technical advantage that, using the method described, the user of the development environment may modify the existing graphical diagram based on the textual intermediate representation by carrying out a textual programming operation, taking into account the textual editor unit. The user may thus make changes to the textual intermediate representation of the graphical diagram displayed in the textual editor unit by carrying out a textual programming operation and thereby creating a modified textual intermediate representation. In order to do so, the user may enter corresponding input commands into the textual editor unit in order to modify the displayed textual intermediate representation. The textual input commands include adding or removing textual program objects from the textual intermediate representation. According to the application, the textual program objects are textual representations of the graphical program objects of the graphical diagram. The graphical program objects are predefined by the rules of the selected graphical programming language.

When the textual intermediate representation is changed in the textual programming process, the textual editor unit receives the corresponding textual input commands entered by the user and makes a corresponding change to the textual intermediate representation displayed in the textual editor unit. This generates a modified textual intermediate representation.

The translation module subsequently translates the modified textual intermediate representation and generates a correspondingly modified graphical diagram. The graphical diagram is then displayed to the user in the graphical editor unit.

The user may thus modify the graphical diagram that was previously generated based on the graphical input commands carried out in the graphical programming process or based on the program file by executing a textual programming process in the textual editor unit and, based on this, generate a modified textual intermediate representation and a correspondingly modified graphical diagram.

The modified graphical diagram and the modified textual intermediate representation represent graphical and textual equivalents of the same control program to be generated. The same applies to the graphical diagram described above and the corresponding textual intermediate representation.

The embodiment of the method according to the application thus provides the user with the option of generating the control program in the selected graphical programming language both in a graphical programming process and in a textual programming process. The user may switch between graphical programming and textual programming as desired, since the changes made in the graphical editor unit are immediately transferred to the corresponding textual intermediate representation and, conversely, the changes made in the textual intermediate representation are immediately taken into account in the corresponding graphical diagram. The graphical diagram and the textual intermediate representation thus represent a clear correspondence to each other at all times, regardless of which editor unit the user has made changes in.

This further simplifies the programming process. Some programming tasks are easier to carry out in the graphical editor unit, while others are easier to accomplish textually. For example, multiplying program objects in the textual intermediate representation is much easier to do using copy & paste than it is in the graphical diagram, in which each graphical program object must be multiplied individually and linked to the existing graphical program objects.

In addition, the resulting control program may be simplified by taking textual programming into account in the textual editor unit, as the case may be, in order to generate a simplified graphical diagram, which may lead to a simplified control program with reduced runtime and reduced computing capacity.

Furthermore, the technical advantage may be achieved that by displaying the textual intermediate representation modified in the textual programming process in the textual editor unit, the user is immediately able to recognize errors or weaknesses in the modified graphical diagram corresponding to the modified textual intermediate representation based on the displayed modified textual intermediate representation.

According to an embodiment, the first translating step further comprises:
determining the graphical program objects, a graphical behavior of the graphical diagram, and at least one behavior position in a behavior determining step, wherein the graphical behavior describes a graphical representation of a program sequence of the control program, and wherein the behavior position defines a position predefined by the IEC 61131-3 standard in a program code at which a behavior of a control program is to be positioned;
translating the graphical program objects and the graphical behavior of the graphical diagram into textual program objects and a textual behavior of the textual intermediate representation in a behavior translating step, wherein the textual behavior represents a textual intermediate representation of the sequence of the control program; and
arranging the textual behavior at the behavior position within the textual intermediate representation in an arranging step.

This may achieve the technical advantage that, by taking the graphical behavior into account in the textual intermediate representation, the textual intermediate representation provides an executable representation of the graphical diagram. By arranging the correspondingly generated textual behavior, which represents a corresponding textual representation of the graphical behavior, within the textual intermediate representation at the behavior position specified for this purpose in the IEC 61131-3 standard, the code provided by the textual intermediate representation complies with the requirements of the IEC 61131-3 standard.

The graphical behavior describes a program sequence of the graphical diagram. The graphical diagram may represent a function, a method, a functional block, or a program section with a plurality of functions, methods, and/or functional blocks. The graphical behavior describes the sequences of the functions, methods, or functional blocks. According to the application, the textual behavior represents a textual description of the graphical behavior. The readable representation of the textual intermediate representation allows for the user to immediately view the textual behavior. By arranging the textual behavior within the textual intermediate representation at the positions designated for behavior, the user is immediately able to identify the textual behavior as such. This facilitates the readability of the textual intermediate representation.

In the sense of the application, a behavior is a description of a function or mode of operation of a program. The behavior includes, for example, a procedure for calculating a functional result based on the parameters of the function.

A behavior position defines, within the meaning of the application, a location within the program code at which the behavior must occur. The behavior position may be specified by guidelines of the respective programming language. In the field of automation and the programming languages used there, the behavior position may be specified in the IEC 61131-3 standard.

According to an embodiment, the first translating step further comprises:
determining the identities of the graphical program objects of the graphical diagram in an identity determining step, wherein the identities of the graphical program objects allow for the respective graphical program objects to be uniquely identified; and
integrating the identities of the graphical program objects into the respective textual program objects of the textual intermediate representation, which are assigned to the graphical program objects and written in textual lines, in an integrating step.

This may achieve the technical advantage that determining the identities of the graphical program objects and integrating the respective identities into the corresponding textual program objects ensures a unique correspondence between the graphical program objects of the graphical diagram and the textual program objects of the textual intermediate representation. Furthermore, integrating the identities of the graphical program objects into the corresponding textual program objects ensures that links between the graphical program objects in the graphical diagram are correctly taken into account in the textual program objects of the textual intermediate representation. By clearly specifying the identities within the textual program objects, which not only identifies the respective textual program objects but also displays the links to other textual program objects, the user may easily determine the correctness of the textual intermediate representation in relation to the graphical diagram by looking at the textual intermediate representation displayed in the textual editor unit. This in turn facilitates the verification of the correctness of the textual intermediate representation, which in turn facilitates the programming process, which in turn may lead to improved control programs.

According to an embodiment, the graphical program objects comprise graphically representable meta information, wherein the meta information comprises at least one of the following: author, creation date, version of the graphical diagram.

This may achieve the technical advantage that additional information visible to the user regarding the creation of the graphical diagram or regarding the creation of the associated textual intermediate representation may be provided in the graphical diagrams. Since the meta information is directly visible to the user on the respective graphical program objects within the graphical diagram, the user may immediately read the meta information by simply viewing the graphical diagram and draw conclusions about the creation of the graphical diagram. Furthermore, the user may directly see which version of the graphical diagram or textual intermediate representation the respective graphical program object originates from. This allows for the user to read the programming progress directly from the graphical diagram.

According to an embodiment, the identities of the linked graphical program objects are integrated into the corresponding textual program objects for linked graphical program objects.

This may achieve the technical advantage that the integration of the identities into the respective textual lines of the linked graphical program objects allows for a clear structure and arrangement of the textual lines in the textual intermediate representation. The integrated identities also allow for users to directly view the structure of the graphical diagram. The individual links are immediately visible. Furthermore, the identities may be used to arrange the textual lines by arranging the lines in the textual intermediate representation according to the identities.

According to an embodiment, the method further comprises:
combining the textual intermediate representation of the graphical diagram with at least one further intermediate representation of at least one further graphical diagram to form a textual overall intermediate representation in a summarizing step, wherein in the overall intermediate representation a plurality of different textual intermediate representations of a plurality of different graphical diagrams are combined to form a coherent code in textual form.

This may achieve the technical advantage that a coherent code for the entire control program may be provided in the form of the overall textual intermediate representation. Individual executable objects of the control program may be represented or programmed using different graphical diagrams, also using different graphical programming languages, as the case may be. The respective textual intermediate representations may be combined in the overall textual intermediate representation. This means that only one coherent code in the form of the overall textual intermediate representation is required to represent the entire control program.

The text of the overall textual intermediate representation is also readable by the user as a coherent text. The entire control program is thus stored in a common file and is available to the user in a readable form. The behavior of the respective graphical diagrams is arranged in the textual overall intermediate representation according to the behavior positions specified by the IEC 61131-3 standard. The textual overall intermediate representation thus provides a textual form of an executable control program that meets the requirements of the IEC 61131-3 standard.

According to an embodiment, the generating step comprises:
carrying out a debugging process based on the textual intermediate representation of the graphical diagram in a debugging step; and/or
generating a binary representation of the control program in a binary code generating step.

This may achieve the technical advantage of allowing for debugging of the generated control program directly based on the textual intermediate representation of the graphical diagram. The textual intermediate representation is therefore not only a textual representation of the graphical diagram that may be displayed to the user in the textual editor unit for correction purposes. The textual intermediate representation is also used directly as a basis in further compilation processes of the control program. The graphical diagram, on the other hand, merely represents a graphical representation of the textual intermediate representation, which may be displayed to the user in the graphical editor unit and which the user may modify with the aid of the graphical programming process known in the prior art for graphical programming languages. The textual intermediate representation, on the other hand, represents the representation that is decisive for generating the control program in the compilation process.

Furthermore, the technical advantage may be achieved that the binary representation of the control program provides an executable representation of the control program.

According to an embodiment, the graphical programming language is one of the following: contact plan, functional block language, sequence language.

This may achieve the technical advantage that the method according to the application may be applied to the graphical programming languages commonly used in automation technology and defined in the IEC 61131-3 standard.

According to an embodiment, a syntax of the textual intermediate representation and the modified textual intermediate representation is conflict-free with a syntax of the graphical programming language.

This may achieve the technical advantage that the conflict-free syntax of the textual intermediate representation with the syntax of the graphical programming language makes it possible to provide a clear textual intermediate representation that may be reliably used for programming a control program based on the graphical programming language.

According to an aspect, a development environment is provided with a graphical editor unit, a textual editor unit, and a translation module, wherein the development environment is set up to carry out the method for generating a control program for an automation system according to one of the preceding embodiments.

This may achieve the technical advantage of providing an improved development environment that is set up to carry out the method according to the application for generating a control program for an automation system with the above-mentioned technical advantages.

### BRIEF DESCRIPTION OF THE DRAWINGS

The application is described in more detail with reference to the accompanying figures, in which:

FIG. 1 shows a schematic depiction of a system for generating a control program for an automation system according to an embodiment;

FIG. 2 shows a further schematic depiction of a system for generating a control program for an automation system according to a further embodiment;

FIG. 3 is a graphical depiction of steps of a method for generating a control program for an automation system according to an embodiment;

FIG. 4 is a further graphical representation of further steps in the method for generating a control program for an automation system according to an embodiment;

FIG. 5 shows a flowchart of the method for generating a control program for an automation system according to an embodiment;

FIG. 6 shows a further flowchart of the method for generating a control program for an automation system according to a further embodiment; and

FIG. 7 is a further flowchart of the method for generating a control program for an automation system according to a further embodiment.

### DETAILED DESCRIPTION

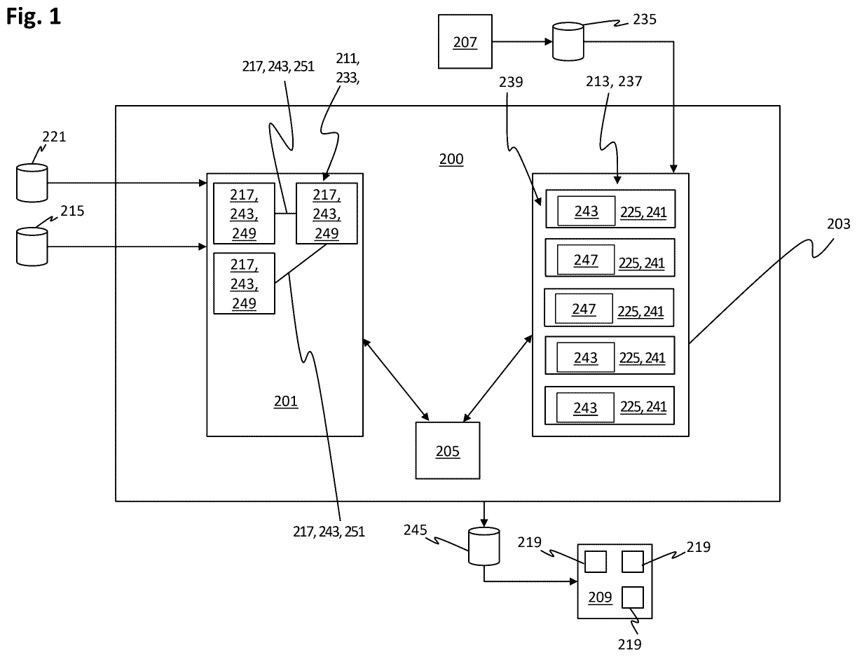

FIG. 1 shows a schematic representation of a system for generating a control program 209 for an automation system according to an embodiment.

According to the application, a development environment 200 suitable for carrying out the method according to the application for generating a control program 209 for an automation system comprises a graphical editor unit 201, a textual editor unit 203, and a translation module 205.

The graphical editor unit 201 is embodied to carry out a graphical programming operation according to a graphical programming language known from the prior art. The graphical editor unit 201 may have all input devices and display devices known from the prior art that are required for carrying out a graphical programming operation.

The textual editor unit 203 is embodied for a textual programming process. For this purpose, the textual editor unit 203 may comprise all display devices and input devices known from the prior art that are required to carry out a textual programming process.

According to the application, the translation module 205 is embodied to translate a translation process between the graphical diagrams 211 of a predefined graphical programming language displayed or generated in the graphical editor unit 201 into corresponding textual intermediate representations 213. In addition, the translation module 205 is set up to perform a reverse translation in which textual intermediate representations 213 displayed or generated in the textual editor unit 203 are translated into corresponding graphical diagrams 211 of a previously selected graphical programming language.

According to an embodiment, the graphical programming languages taken into account by the method according to the application or the development environment 200 according to the application comprise the languages contact plan, functional block language, and sequence language, which are each predefined in the IEC 61131-3 standard for automation technology.

The translation module 205 is accordingly capable of converting the aforementioned programming languages into textual intermediate representations 213.

According to the application, the textual intermediate representations 213 are written in a form that is readable by the user. The textual intermediate representations 213 are written in a form that is based on a known and readable language, such as English, German, Spanish, Mandarin, or a similar common world language. The letters, terms, or characters/special characters used are taken from the aforementioned natural languages. In addition, the textual intermediate representations 213 are displayed as lines and may be read within a display field of the textual editor unit 203 from top left to bottom right, or follow another recognized convention for readability.

In addition to the components shown, the development environment 200 may comprise additional components that are required for a compilation process or a programming process of a control program. These may comprise input or output interfaces, a compiler, a debugging module, and other components known from the prior art for programming.

In order to carry out the method according to the application for generating a control program for an automation system, a graphical diagram 211 is first translated by the translation module 205 into a corresponding textual intermediate representation 213.

The graphical diagram 211 is a graphical representation of at least part of the control program 209 to be programmed. The graphical diagram 211 comprises at least one graphical program object 217. The graphical program object 217 represents a graphical representation of a program object 219 of the control program 209.

The graphical diagram 211 represents at least one executable structure of the control program 209, for example a function, a method or a functional block.

The translation of the graphical diagram 211 with the aid of the translation module 205 generates a textual intermediate representation 213. The textual intermediate representation 213 represents a textual description of the graphical diagram 211 and comprises at least one textual program object 225.

The textual program object 225 corresponds to the graphical program object 217 of the graphical diagram 211 and represents a textual description of the graphical program object 217. The textual program object 225 comprises at least one description of the type and function of the graphical program object 217. The types or modes of operation of the graphical program objects 217 are defined by the IEC 61131-3 standard.

If the graphical diagram 211 comprises a plurality of interconnected graphical program objects 217, as shown in FIG. 1, the corresponding textual program objects 225 also comprise information relating to the connection with other textual program objects 225.

According to the application, the translation of the graphical diagram 211 into the textual intermediate representation 213 is carried out line by line. In this process, each graphical program object 217 is assigned a corresponding textual program object 225. The textual program object 225 is represented by at least one textual line 241 of the textual intermediate representation 213. Preferably, the textual program objects 225 are generally represented by exactly one textual line 241 within the textual intermediate representation 213.

The textual intermediate representation 213 generated accordingly thus comprises, depending on the number of graphical program objects 217 of the graphical diagram 211, a plurality of textual program objects 225 written as textual lines 241.

In the example shown in FIG. 1, the graphical diagram 211 comprises five graphical program objects 217. The five graphical program objects 217 comprise three node objects 249, which are each connected to one another via two edge objects 251.

The graphical diagram 211 shown in this context is only an example of possible graphical diagrams 211 of the programming languages contact plan, functional block language, and sequence language.

In graphical diagrams 211 having a plurality of graphical program objects 217, the graphical program objects 217 are each provided with an identity 243. The graphical program objects 217 may be uniquely identified via the identities 243. The identities 243 may, for example, be embodied as character and/or digit sequences.

When the graphical diagram 211 is translated into the textual intermediate representation 213, the identities 243 of the graphical program objects 217 are integrated into the corresponding textual program objects 225. For this purpose, the identities 243 are integrated into the textual lines 241 of the textual program objects 225. This allows for a unique assignment between the graphical diagram objects 217 and the corresponding textual program objects 225.

In the case of linked graphical program objects 217, the textual program objects 225 may contain, in addition to the identities 243 of the respective graphical program objects 217, the identities 243 of the graphical program objects 217 linked to the respective graphical program objects 217. From this, the user may directly read the link between the various graphical program objects 217 from the textual intermediate representation 213 using the identities 243.

The textual program objects 225 represented in the form of textual lines 241 may be arranged in the textual intermediate representation 213 according to the respective identities 243 of the graphical program objects 217 integrated into the textual program objects 225.

In addition to information regarding the type and/or functions of the respective graphical program objects 217, the corresponding textual program objects 225 may also contain additional information.

For example, position information of the graphical program objects 217 may be integrated into the textual program objects 225. The position information describes position information relating to the positioning of the respective graphical program objects 217 of the graphical diagram 211 within the display device of the graphical editor unit 201. The position information may comprise, for example, x and y coordinates.

In addition to the position information, size information may also be included, which also defines a size of the respective graphical program object 217 within the display device of the graphical editor unit 201 via the x and y coordinates.

The position or size information that relates exclusively to the graphical representation of the graphical program objects 217 in the graphical editor unit 201 may, for example, be defined individually by the manufacturer.

According to the application, the correspondingly generated textual intermediate representation 213 is stored in a representation file 245.

The textual intermediate representation 213 stored in the representation file 245, including the plurality of textual program objects 225 formed as textual lines 241, may be read by a version management system 207. The control programs 209 generated according to the method of the application for generating a control program and created according to a graphical programming language may thus be managed in the form of the corresponding textual intermediate representations 213 in a version management system 207.

The textual lines 241 of the textual intermediate representation 213 may be read into the version management system 207. This allows for the version management system 207 to determine changes between different versions of the textual intermediate representations 213 uploaded to the version management system 207. Different versions of the textual intermediate representations 213 describe different versions of the graphical diagram 211, which in turn represent different versions of the control program 209.

According to an embodiment, the development environment 200 may also receive textual difference information 235.

According to the application, the textual intermediate representation 213 is written in a readable form. The representation file 245 comprising the textual intermediate representation 213 is stored in a format readable by a version management system 207.

According to an embodiment, the development environment 200 is set up to receive difference information 235 from a version management system 207. The difference information 235 provides textual information describing a difference between a first version and a second version of the textual intermediate representation 213. The two versions of the textual intermediate representation 213 describe program code of the control program to be generated and may, for example, have been written at different times or by different authors. The textual difference information 235 thus allows for the version management system 207 to display, in compact form, the difference between the versions of the textual intermediate representation 213 written, for example, at different times or by different authors. The textual difference information 235 provided by the version management system 207 thus allows the programming progress of the control program 209 to be generated to be tracked based on the different versions of the textual intermediate representation 213 loaded into the version management system 207.

The textual intermediate representations 213 are generated, as described above, by carrying out a graphical programming operation using the graphical programming language. Different textual intermediate representations 213, which describe a common program code and are therefore based on common graphical diagrams 211, thus differ by at least one textual program object 225, which corresponds to a corresponding graphical program object 217 of the associated graphical diagram 211, and which is contained exclusively in one of the two versions of the textual intermediate representation 213.

In order to change the graphical diagrams 211 during the graphical programming process, graphical program objects 217 may be added to the existing graphical diagram 211 and/or removed from the graphical diagram 211. The newly added graphical program object 217 may be a new graphical program object 217 or a modified graphical program object 217. Accordingly, the textual intermediate representations 213 generated from the graphical diagrams 211 with the aid of the translation process are changed by adding or removing corresponding textual program objects 225. The textual difference information 235 thus comprises at least one textual program object 225 that is contained exclusively in one of the two versions of the textual intermediate representation 213. It is assumed here that the two versions of the textual intermediate representation 213 represent a common control program.

In the application, a change to graphical and/or textual program objects 217, 225 comprises the deletion of the graphical and/or textual program object 217, 225 to be changed and the addition of a correspondingly changed graphical and/or textual program object 217, 225. The same applies to other items to be changed in this application.

The development environment 200 is further configured to display the textual difference information 235 in one of the two versions of the textual intermediate representation 213 within the textual editor unit 203. The corresponding deleted or added textual program objects 225 may be displayed in one or both versions of the textual intermediate representation 213 within the textual editor unit 203 with a corresponding marking as a deleted or added textual program object 217. The deleted or added textual program objects 225 may be marked, for example, with the aid of color or graphics in the form of hatching or other graphic markings.

The correspondingly deleted or added textual program objects 225 of the textual difference information 235 may thus be displayed in one or both of the versions of the textual intermediate representation 213 together with the respective version of the textual intermediate representation 213 within the textual editor unit 203. The textual program objects 225 of the textual difference information 235 that have been added or deleted accordingly may thus be displayed with corresponding markings in the respective versions of the textual intermediate representation 213 inserted in the textual editor unit 203.

Alternatively, the added or deleted textual program objects 225 of the textual difference information 235 may be displayed independently in the textual editor unit 203.

In a further embodiment, a translation of the added or deleted textual program objects 225 of the textual difference information 235 into correspondingly added or deleted graphical program objects 217 may be carried out and corresponding graphical difference information may be generated therefrom.

The added or deleted graphical program objects 265, 267 of the graphical difference information may then be displayed graphically in the versions of the associated graphical diagram 211 corresponding to the textual intermediate representation 213 in the graphical editor unit 201.

In analogy to the deleted or added textual program objects 225, the corresponding deleted or added graphical program objects 217 may be displayed with corresponding graphical or color markings. The added or deleted graphical program objects 217 of the graphical difference information may be displayed in one or both versions of the graphical diagrams 211 in the graphical editor unit 201 in a manner analogous to that described above. The deleted or added graphical program objects 217 may be integrated into the respective versions of the graphical diagram 211. As an alternative or in addition, the deleted or added graphical program objects 217 of the graphical difference information may be displayed separately in the graphical editor unit 201.

By taking into account the textual difference information 235 or the corresponding graphical difference information, the corresponding added or deleted textual program objects 225 or graphical program objects 217 may be displayed to the user at a glance. The corresponding color or graphic marking immediately indicates to the user whether a textual or graphic program object 225, 217 has been deleted or added. This may be indicated to the user, for example, with the aid of the identities 243 of the graphic or textual program objects 217, 225. The user may thus see the programming progress at a glance in the form of the differences between the two versions of the program code.

The two versions of the textual intermediate representation 213 may be based on each other, wherein, for example, the first version was created at an earlier point in time than the second version. Changes between the two versions by inserting a changed textual program object 217 may be represented here, for example, by a pair of textual program objects, wherein the pair comprises a deleted textual program object and an added textual program object. The pair may in this context be determined on the basis of the identities 243 of the respective textual program objects 225.

The deleted textual program object 225 is deleted from the first version of the textual intermediate representation 213, while the added textual program object 225 is added to the second version of the textual intermediate representation 213. The two program objects, the deleted and the added program object 225, each describe the same program object 219 of the control program 209 in the sense of identical identities 243 and based on the same graphical program object 217 of the graphical diagram 211. The added textual program object 217 represents a change to the original textual program object 217, i.e., the textual program object 225 deleted from the first version of the textual intermediate representation 213.

According to a further embodiment, the development environment 200 is also set up to receive textual conflict information 269 from the version management system 207. The textual conflict information 269 describes possible conflicts between the two versions of the textual intermediate representation 213. Possible conflicts between versions of the textual intermediate representation 213 may occur in cases in which a textual program object 225 is assigned to the first version of the textual intermediate representation 213 and another textual program object 225 is assigned to the second version of the textual intermediate representation 213. The two textual program objects 225 describe the same program object 219 of the control program 209 in the sense of identical identities 243 and are based on the same graphical program object 217 of the graphical diagram 211. The two textual program objects 225 accordingly have the same identity 243 as the corresponding graphical program object 217, but are modified or different relative to each other.

The development environment 200 is also set up to determine corresponding conflicts between the two versions of the textual intermediate representation 213 based on the textual conflict information 269. For this purpose, a corresponding conflict check is carried out and an existing conflict between two versions of the textual intermediate representation 213 is determined if the textual conflict information 269 lists a pair of textual program objects 217, both of which have the same identity 243 of a corresponding graphical program object 217, but one of which is assigned to the first version of the textual intermediate representation 213 while the other textual program object 225 is assigned to the corresponding second version of the textual intermediate representation 213.

Corresponding conflicts may occur, for example, in modified textual program objects 225 which, as described above, consist of a pair consisting of a deleted textual program object 225 and an added textual program object 225, each of which refers to the same graphical program object 217.

The two versions of the textual intermediate representation 213 may have been edited and modified by two different developers. The corresponding versions of the textual intermediate representation 213 may be based on a common textual intermediate representation 213, relative to which the versions of the textual intermediate representation 213 have been modified. The modified textual program objects 225 have the same identity 243, but are defined differently from one another.

According to a further embodiment, the textual conflict information 269 may be translated into graphical conflict information. In this context, the corresponding textual program objects 225 of the textual conflict information 269 are translated into corresponding graphical program objects 217.

The correspondingly generated graphical conflict information 271 may then be displayed in the graphical editor unit 201.

The conflict may then be resolved by deleting one of the textual or graphical program objects 217, 225 from one of the two versions of the graphical intermediate representation 213 or the graphical diagram 211.

In order to generate the graphical diagram 211, the method for generating a control program for an automation system also includes taking into account graphical input commands 215 that are entered into the development environment 200 by a user during a graphical programming process, and/or information from a program file 221 for creating the graphical diagram 211.

A graphical diagram 211 is stored in the program file 221 in textual form. By reading the information from the program file 221, the development environment 200 allows for the graphical editor unit 201 to generate a corresponding graphical diagram 211 in accordance with the information in the program file 221 and display it to the user in the graphical editor unit 201.

This alternative describes the case in which an existing graphical diagram 211 stored in the program file 221 is loaded by the development environment 200 and displayed to the user in the graphical editor unit 201 for further processing.

According to a further alternative, the aforementioned graphical input commands 215 are taken into account for generating the graphical diagram 211. The graphical input commands 215 are programming commands that are transmitted by a user of the development environment 200 to the graphical editor unit 201 in a graphical programming process. The graphical input commands 215 may, for example, include adding or removing graphical program objects 217 from the graphical diagram 211.

This alternative describes the case in which, during a graphical programming process by a user of the development environment 200 within the graphical editor unit 201, a graphical diagram 211 is modified or a graphical diagram 211 is completely regenerated.

The present application also comprises a combination of the two alternatives, in which, for example, an existing graphical diagram 211 stored in textual form in the program file 221 is first uploaded to the graphical editor unit 201 by reading in the information from the program file 221 and is displayed to the user in the graphical editor unit 201 for further processing.

By executing a graphical programming process in which the user transmits graphical input commands 215 to the graphical editor unit 201 in the form of adding or removing graphical program objects 217 to or from the graphical diagram 211, thereby modifying or further developing the graphical diagram previously loaded into the graphical editor unit 201 based on the information in the program file 221 is modified or further developed.

Based on the graphical input commands 215 and/or based on the information in the program file 221, the graphical editor unit 201 then generates the graphical diagram 211.

According to an embodiment, the graphical diagram 211 generated in this way may also be displayed in the graphical editor unit 201.

Similarly, the textual intermediate representation 213 generated by translating the graphical diagram 211 may be displayed in the textual editor unit 203.

This allows the user to detect and, as the case may be, correct errors in the graphical diagram 211.

The control program 209 may then be generated based on the graphical diagram 211 and/or based on the textual intermediate representation 213.

According to an embodiment, in order to translate the graphical diagram 211 into the textual intermediate representation 213, the graphical program objects 217 and a graphical behavior 233 of the graphical diagram 211 as well as a behavior position 239 of the graphical behavior 233 are first determined.

The graphical behavior 233 describes the program flow of the graphical diagram 211. The behavior position 239, on the other hand, describes a position predefined in the IEC 61131-3 standard at which corresponding behaviors are to be arranged in a program code.

The graphical behavior may be determined by taking into account volatile representations of the graphical diagram 211. As is known from the prior art, graphical diagrams 211 written in graphical programming languages are represented in volatile representations. The volatile representations are not stored permanently in memory, but exist exclusively during the creation or display of the graphical diagrams in the graphical editor unit 201 in the working memory of the computer carrying out the development environment 200. The volatile representations are available as bit sequences and represent the individual components, including the graphical program objects 217 of the graphical behavior, of the graphical diagram 211.

By reading in the volatile representations, the development environment 200 may identify the graphical program objects 217 and the graphical behavior. The reading in also allows for the position information and size information of the graphical diagram 211 and the graphical program objects 217 contained therein to be determined. The position and size information describe the positions and sizes at and with the aid of which the individual components, i.e., the graphical program objects 217, are displayed in the graphical editor unit 201.

Taking into account the volatile representations of the graphical diagram 211, the corresponding textual intermediate representation 213, including the textual program objects 225 and the textual behavior 237, may be translated from the graphical diagram 211.

According to an embodiment, after generating the textual intermediate representation 213 and displaying the textual intermediate representation 213 in the textual editor unit 203 based on the graphical diagram 211 and/or based on the textual intermediate representation 213, the control program 209 represented by the graphical diagram 211 and the textual intermediate representation 213 is generated.

For this purpose, according to an embodiment, a debugging process based on the textual intermediate representation 213 may first be carried out. For this purpose, the development environment 200 may comprise a component set up to carry out a debugging process, for example in the form of a compiler.

According to an embodiment, the control program 209 is generated in a binary representation. The binary representation may in turn be stored in the representation file 245.

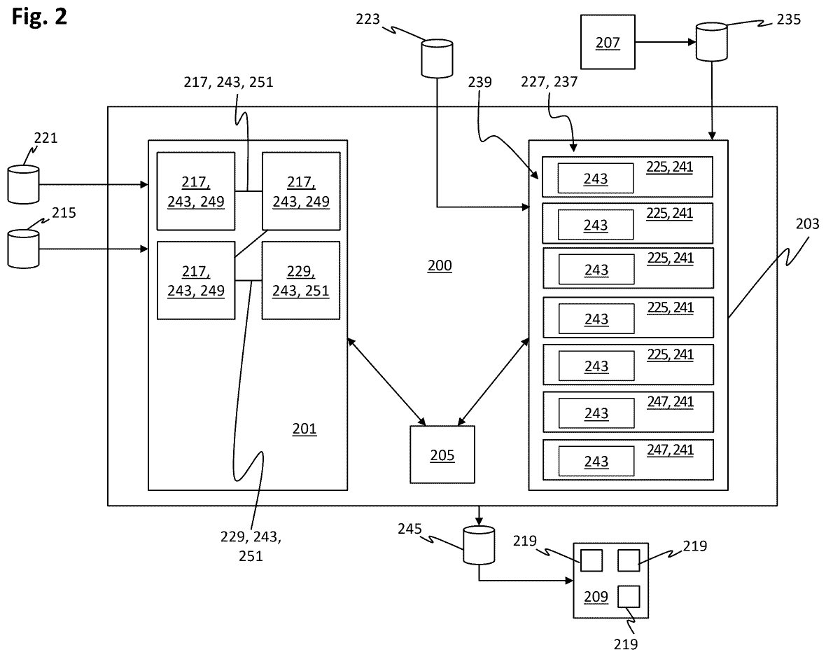

FIG. 2 shows a further schematic depiction of a system for generating a control program 209 for an automation system according to a further embodiment.

The embodiment in FIG. 2 is based on the embodiment in FIG. 1 and comprises all the features described therein. Unless these have been changed in the embodiment in FIG. 2, a detailed description is dispensed with.

In the embodiment shown, the development environment 200 is capable of providing the user with the option of a textual programming process. The textual programming process is carried out on the textual intermediate representation 213. The textual programming process thus allows the user to modify the textual intermediate representation 213 of FIG. 1, for example by adding or removing textual program objects 225 to or from the textual intermediate representation 213, and generate a modified textual intermediate representation 227.

For this purpose, corresponding textual input commands 223 are received by the textual editor unit 203. The textual input commands 223 describe the programming commands entered by the user during the textual programming process, with the aid of which textual program objects 225 are added or removed. The textual input commands 223 may depend individually on the language used to represent the textual intermediate representations 213 or modified textual intermediate representations 227 or the textual program objects 225 and on the respective individual textual descriptions of the graphical program objects 217 in the textual program objects 225.

The syntax of the textual intermediate representation 213 or modified textual intermediate representations 227 corresponds to the syntax of the graphical programming language predefined in the above-mentioned standard IEC 61131/3.

In the embodiment shown, the modifications to the textual intermediate representation 213 of FIG. 1 based on the textual input commands 223 of the user comprise the addition of two further textual program objects 247. The two additional textual program objects 247 are represented textually in accordance with the original textual program objects 225 by textual lines 241 in accordance with the properties described above.

By carrying out a translation process by the translation module 205, a correspondingly modified graphical diagram 231 is generated from the modified textual intermediate representation 227. In the modified graphical diagram 231, two further graphical program objects 229 are integrated in accordance with the modified textual intermediate representation 227. In the embodiment shown, the two further graphical program objects 229 are connected to the graphical program objects 217 to form a coherent graphical diagram.

In the embodiment shown, the user is thus able to modify a previously generated graphical diagram 217 by carrying out a corresponding textual programming operation. The user is thus able to generate the control program 209 based on the previously selected graphical programming language both by executing a graphical programming operation as described in FIG. 1 and by executing a text-based programming operation as described in FIG. 2.

The user may thus select the most convenient programming method at will and may also switch between the various textual and graphical programming operations during programming. The changes made during one programming process are immediately displayed in the other representation with the aid of translation. The changes made in the graphical diagram 211 are immediately displayed in the textual intermediate representation 213 or modified textual intermediate representations 227 with the aid of translation. Similarly, changes made in the textual intermediate representation 213 or modified textual intermediate representations 227 are displayed immediately after translation in the graphical diagram 211 or the modified graphical diagram 231.

Graphical program objects 217 that have been newly added or deleted in the graphical diagram 211 are displayed accordingly as newly added or deleted textual program objects 225 in the textual intermediate representation 213 or integrated into or deleted from it.

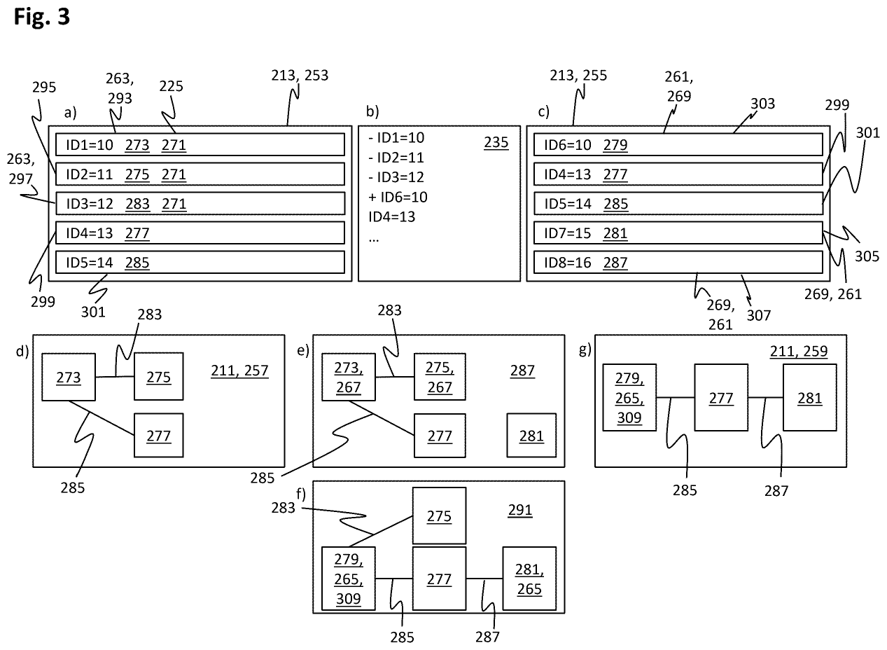

FIG. 3 shows a graphical depiction of the steps of a method 100 for generating a control program 209 for an automation system according to an embodiment.

FIG. 3 graphically shows how the development environment 200 takes into account the difference information 235 of the version management system 207. The difference information 235 comprises information relating to a difference between a first version 253 of the textual intermediate representation 213 and a second version 255 of the textual intermediate representation 213.

Block a) of FIG. 3 shows the first version 253 of the textual intermediate representation 213, block b) shows the textual difference information 235, and block c) shows the second version 255 of the textual intermediate representation 213.

In the first version 253 of the textual intermediate representation 213, five textual program objects 225 are shown as examples in the form of a first textual program object 293, a second textual program object 295, a third textual program object 297, a fourth textual program object 299, and a fifth textual program object 301.

The second version 255 of the textual intermediate representation 213 also comprises five textual program objects 225 in the form of a sixth textual program object 303, the fourth textual program object 299, the fifth textual program object 301, a seventh textual program object 305, and an eighth textual program object 307.

The textual difference information 235 shows the differences between the first version 253 of the textual intermediate representation 213 and the second version 255 of the textual intermediate representation 213 in textual form. In the embodiment shown, the individual textual program objects 225 of the first and second versions 253, 255 of the textual intermediate representation 213 are represented with the respective identities ID1, ID2, ID3, ID4, ID5, ID6. Furthermore, the textual program objects 225 shown are represented by the plus or minus signs shown as deleted or added textual program objects 261, 263. The textual difference information 235 may thus be used to achieve a transition from the first version 253 of the textual intermediate representation 213 to the second version 255 of the textual intermediate representation 213 or in the opposite direction.

The first textual program object 293 describes a first node object 273 of a graphical diagram 211. The second textual program object 295 describes a second node object 275, the fourth textual program object 299 describes a third node object 277, the third textual program object 297 describes an edge object 283 between the first node object 273 and the second node object 275, the fifth textual program object 301 describes an edge object 285 between the first node object 273 and the third node object 277. The sixth textual program object 303 describes a fourth node object 279 and the seventh textual program object 305 describes a fifth node object 281. The eighth textual program object 307 describes an edge object 287 between the third node object 277 and the fifth node object 281.

In analogy to the embodiment of FIG. 1, the textual program objects 225 of the first and second versions 253, 255 of the textual intermediate representation 213 are provided with identities 243 of the corresponding graphical program objects 217.

The first textual program object 293 comprises a first identity ID1, the second textual program object 295 comprises a second identity ID2, the third textual program object 297 comprises a third identity ID3, the fourth textual program object 299 comprises a fifth identity ID5, the sixth textual program object 303 comprises a sixth identity ID6, the seventh textual program object 305 comprises a seventh identity ID7, and the eighth textual program object comprises an eighth identity ID8. The identities 243 identify the respective graphical program objects 217 of the graphical diagram 211 referenced by the textual program objects 225.

The textual program objects 225 are represented in the first and second versions 253, 255 of the textual intermediate representation 213 in textual lines 241 in accordance with the application.

In the first version 253 of the textual intermediate representation 213, the first textual program object 293, the second textual program object 295, and the third program object 297 are each marked as deleted textual program objects 263. The first to third textual program objects 293, 295, 297 are thus not listed in the second version 255 of the textual intermediate representation 213 in the form of the first version 253 of the textual intermediate representation 213.

The fourth textual program object 299 and the fifth textual program object 301, on the other hand, are transferred unchanged to the second version 255 of the textual intermediate representation 213.

The seventh textual program object 305 and the eighth textual program object 307, on the other hand, represent textual program objects 265 that have been added to the second version 255 of the textual intermediate representation 213 compared to the first version 253 of the textual intermediate representation 213.

The sixth textual program object 303 represents a textual program object that has been changed in the second version 255 of the textual intermediate representation 213 compared to the first version 253 of the textual intermediate representation 213. The sixth textual program object 303 is based on the first textual program object 293. This is characterized in that the first identity ID1 of the first textual program object 293 has the same numerical value as the sixth identity ID6 of the sixth textual program object 303.

The first textual program object 293 and the sixth textual program object 303 represent a pair consisting of a deleted textual program object 263 and an added textual program object 261. The sixth textual program object 303 newly added in the second version 255 of the textual intermediate representation 213 is changed here with respect to the first textual program object 293 of the first version 253 of the textual intermediate representation 213.

Blocks d) to g) of FIG. 3 show graphical diagrams 211 representing different stages of a transition between the first version 253 of the textual intermediate representation 213 and the second version 255 of the textual intermediate representation 213. A graphical diagram 211 shown in graphic d) describes the first version 253 of the textual intermediate representation 213. The graphical diagram 211 in graphic d) comprises the first node object 273, the second node object 275, and the third node object 277. The first node object 273 and the second node object 275 are connected to each other by the edge object 283. The first node object 273 and the third node object 277 are connected accordingly via the edge object 285. The graphical diagram 211 in block d) shows a first version 257 of the graphical diagram 211.

The graphical diagram 211 in block g) of FIG. 3, on the other hand, describes the second version 255 of the textual intermediate representation 213 and thus represents a second version 259 of the graphical diagram 211. The graphical diagram 211 accordingly comprises the fourth node object 279, the third node object 277, and the fifth node object 281. The fourth node object 279 is connected to the third node object 277 via the edge object 285. The third node object 277 is connected to the fifth node object 281 via the edge object 287.

Both blocks e) and f) of FIG. 3 now show steps in which the second version 259 of the graphical diagram 211 may be created from the first version 257 of the graphical diagram 211. In graphic e), relative to the first version 257 of the graphical diagram 211, the fifth node object 281 is first added and connected to the third node object 277 via the edge object 287.

In graphic e), the first node object 273 is marked as a deleted graphical program object 267. The same applies to the second node object 275, which is also marked as a deleted graphical program object 267. In addition, the fifth node object 281 and the edge object 287 are marked as correspondingly added graphical program objects 265.

In graphic f), the first node object 273 is replaced by the fourth node object 279 compared to graphic e). The fourth node object 279 is connected to the second node object 275 and the third node object 277 via the edge objects 283, 285 in the same way as the first node object 273.

Starting from graphic f), to obtain the second version 259 of the graphical diagram 211 of graphic g) corresponding to the second version 255 of the textual intermediate representation 213, the second node object 275 and the edge object 283 are deleted.

In blocks d) to g) of FIG. 3, the difference between the first node object 273 and the fourth node object 279 is primarily due to the position of the node object within the graphical diagram 211. There may be further differences in the functions or effects of node objects 273 and 279.

The embodiment of the graphical diagrams 211 and the textual intermediate representations 213 in FIG. 3 are merely examples and are intended solely to illustrate the functioning of the present method.

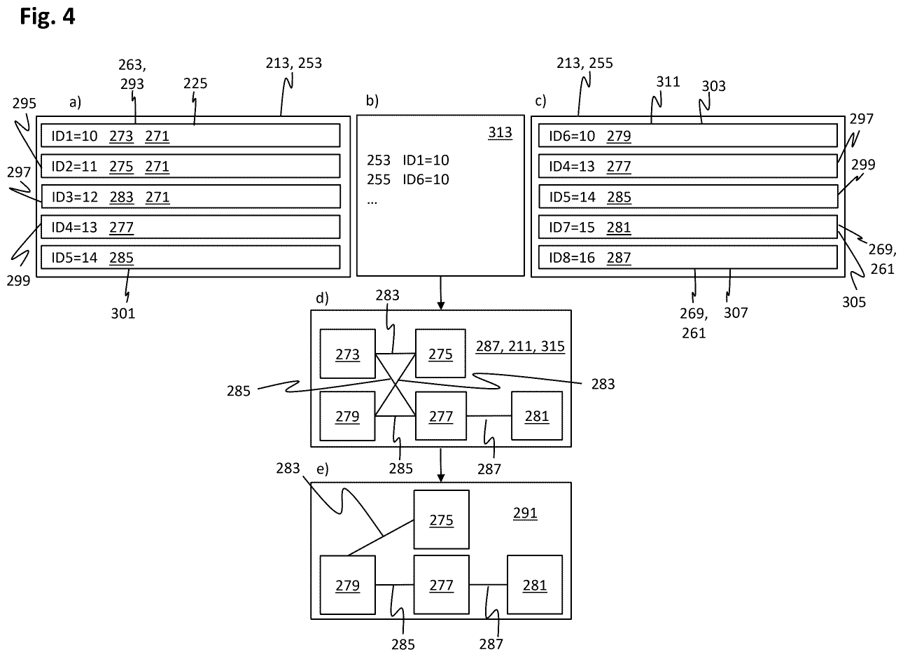

FIG. 4 shows a further graphical representation of further steps of method 100 for generating a control program 209 for an automation system according to an embodiment.

FIG. 4 shows the first and second versions 253, 255 of the textual intermediate representation 213 of FIG. 3. Furthermore, textual conflict information 269 is shown. The textual conflict information 269 shows the various textual program objects 225 of the different versions 253, 255 of the textual intermediate representation in textual form. In analogy to the difference information 235 in FIG. 3, the textual program objects 225 are represented by their identities ID1, ID2, ID3, ID4, ID5, ID6, ID7, ID8. Furthermore, the textual conflict information 269 specifies the corresponding version 253, 255 of the textual intermediate representation 213 to which the respective textual program object 225 is assigned for each textual program object 225 displayed.

In block d) of FIG. 4, the diagram includes all elements of the first and second versions 253, 255 of the textual intermediate representation 213 and thus shows the conflicts between the two versions 253, 255. Thus, the graphical diagram 211 of block d) includes the first node object 273, the second node object 275, and the third node object 277, as well as the edge object 283 and the edge object 285 of the first version 253 of the textual intermediate representation 213. Furthermore, the graphical diagram 211 comprises the fourth node object 279, the fifth node object 281, and the edge object 287 of the second version 255 of the textual intermediate representation 213.

In the embodiment shown, the first node object 273 and the fourth node object 279 are based on a common node object as a basis, but are different from each other. This may occur, for example, if the control program is developed by different developers who each create different versions of the control program or the graphical diagrams 211 and/or the textual intermediate representations 213. In the respective versions, the aforementioned node objects 273, 279 were developed in different forms. Both node objects 273, 279 are therefore based on the same object, and consequently have the same identity, which is represented by the same numerical value of the first identity ID1 of the first textual program object 293 and the first node object 273, and the sixth identity ID6 of the sixth textual program object 303 and the fourth node object 279, but differ from each other.

The two node objects 273, 279 therefore represent a conflict, since both node objects 273, 279 have the same identity and thus refer to the same program object 219 of the control program 209, but are assigned different versions 253, 255 of the textual intermediate representation 213 and the program code of the control program 209, respectively, and are different from each other. For example, both node objects 273, 279 describe a function or a variable, but these are defined differently in the respective versions.

Furthermore, the graphical diagram 211 of the graphic d) comprises the third node object 277 and the edge object 285 connecting the first node object 273 and the third node object 277 and the fourth node object 279 and the third node object 277, respectively. Both the third node object 277 and the edge object 285 are transferred from the first version 253 to the second version 255 of the textual intermediate representation 213 without any changes and therefore do not represent a conflict.

To resolve the conflict, the development environment 200 is able to identify the individual textual program objects 225 from the textual conflict information 269 and assign them to the different versions 253, 255 of the textual intermediate representation 213.

In the example shown, the development environment 200 is explicitly able to determine that the first textual program object 293 and the sixth textual program object 303 are based on a common object.

The development environment 200 thus recognizes that the first textual program object 293 of the first version 253 of the textual intermediate representation 213 and the sixth textual program object 303 of the second version 255 of the textual intermediate representation 213 are based on a common textual program object 225 and have been changed independently of each other in the respective versions of the textual intermediate representation 213 from each other in the respective versions of the textual intermediate representation 213. In order to resolve the conflict, in the example shown, the development environment 200 deletes the first node object 273 corresponding to the first program object 293 from diagram 211 of graphic d) and replaced by the fourth node object 279 corresponding to the sixth textual program object 303 of the second version 255.

Alternatively, the fourth node object 279 corresponding to the sixth textual program object 303 may be deleted from the graphical diagram 211.

Alternatively, the development environment 200 displays the program object 293 to be deleted to the user so that the user may delete the program object 293 manually.

The fourth textual program object 299 and the fifth textual program object 301 are transferred unchanged to the second version 255 of the textual intermediate representation 213, as there is no conflict here.

Accordingly, the graphical diagram 211 of graphic e) is generated, in which the conflict is resolved and which corresponds to the second version 255 of the textual intermediate representation 213.

In the event of further conflicts, the development environment 200 proceeds accordingly with further objects of the textual conflict information 269 and deletes the corresponding graphical program objects 217 or leaves them in the respective graphical diagram 211. Alternatively, this may also be done manually by the user.

FIG. 4 shows the case in which the two versions 253 and 255 of the textual intermediate representation 213 are based on a common version.

Alternatively, based on the conflict information 269, the conflicts are displayed to a user by the development environment 200 so that the conflicts may be resolved manually by the user.

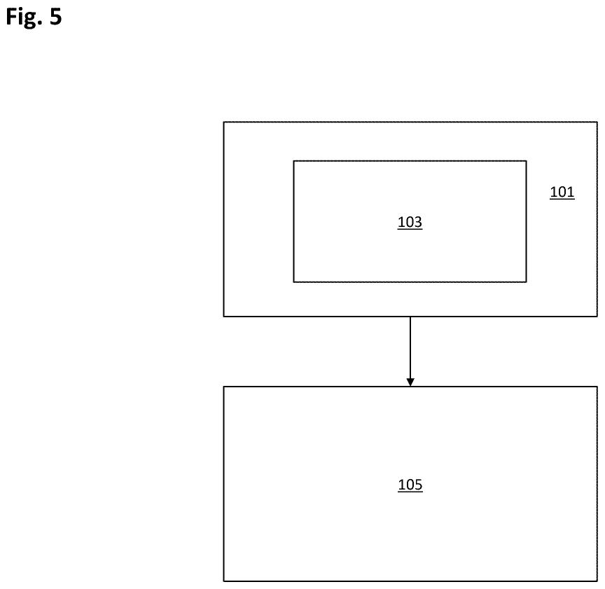

FIG. 5 shows a flowchart of the method 100 for generating a control program 209 for an automation system according to an embodiment.

In order to generate a control program 209, a graphical diagram 213 of a graphical programming language is first translated into a textual intermediate representation 213 of the graphical diagram 211 in a first translating step 101 by the translation module 205 of the development environment 200.

The graphical diagram 211 graphically represents at least part of the control program 209 to be generated in accordance with the graphical programming language. The textual intermediate representation 213 also provides a textual description of the graphical diagram 211. For this purpose, the graphical diagram comprises at least one graphical program object 217, each of which represents a graphical representation of a program object 219 of the control program 209. The textual intermediate representation 213 accordingly comprises at least one textual program object 225, which is a textual description of the graphical program object 217 of the graphical diagram 211.

In order to translate the graphical diagram 211, a line-by-line translation of the graphical diagram 211 into the intermediate representation 213 is carried out in a line translating step 103. In the line-by-line translation, each graphical program object 217 is assigned at least one textual program object 225 in the form of a textual line 241 of the textual intermediate representation 213. The textual lines 241 represent a unique description of the respective graphical program objects 217.

The graphical programming language may be a graphical programming language defined by the IEC 61131-3 standard, for example, contact diagram, functional block language, sequence language.

The textual intermediate representation 213 is preferably written in a version that is readable by the user of the development environment 200.

Finally, in a storing step 105, the textual intermediate representation 213 or on which the generated control program 209 is based is stored in a representation file 245.

Preferably, the textual intermediate representation 213 is stored in the representation file 245 in a form that may be read by a version management system known from the prior art.

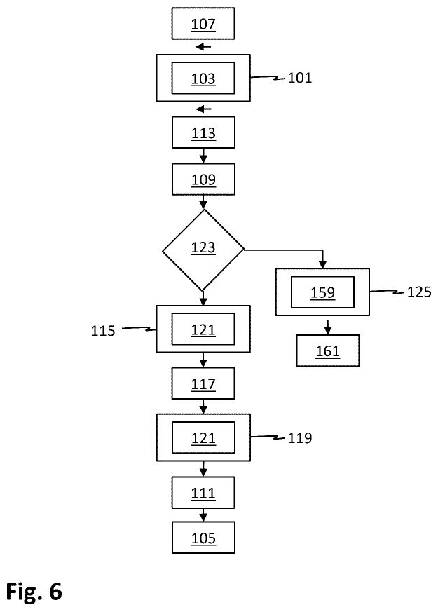

FIG. 6 shows a flowchart of the method 100 for generating a control program 209 for an automation system according to an embodiment.

The embodiment shown in FIG. 6 is based on the embodiment in FIG. 5 and comprises all the method steps shown therein. Unless these have been changed, they are not described again.

In the embodiment shown, the graphical diagram 211 is displayed in a first displaying step 107 in the graphical editor unit 201 of the development environment 200. The graphical editor unit 201 may comprise a corresponding display device for this purpose.

Furthermore, in a receiving step 113, the development environment 200 first receives textual difference information 235 from a version management system 207.

The textual difference information 235 describes a difference between a first version 253 of the textual intermediate representation 213 and a second version 255 of the textual intermediate representation 213. The first version 253 and the second version 255 of the textual intermediate representation 213 are each representations of a first version 257 and a second version 259 of the graphical diagram 211. The first and second versions 257, 259 of the graphical diagram 211 may each have been created in the programming process one after the other and/or by different users.

The textual difference information 235 further defines at least one textual program object 225 that is contained only in one of the two versions 253, 255 of the textual intermediate representation 213. The textual difference information 235 thus describes the differences between versions 253 and 255 of the textual intermediate representation 213 in textual form.

The different versions 253, 255 of the textual intermediate representation 213 correspond to different versions of the graphical diagram 211, which in turn represent different versions of the generated program code of the control program 209.

In a second displaying step 109, the textual intermediate representation 213 generated by translating the graphical diagram 211 is displayed in a textual editor unit 203 of the development environment 200.

The user may thus check the functionality or correctness of the graphical diagram 211 or the control program 209 by inspecting the displayed graphical diagram 211 or the displayed textual intermediate representation 213.

In the embodiment shown, the method further comprises a conflict detecting step 123. In the conflict detecting step 123, the development environment 200 receives textual conflict information 269 from the version management system 207 and carries out a conflict check between the first version 253 of the textual intermediate representation 213 and the second version 255 of the textual intermediate representation 213.

The textual conflict information 269 comprises textual program objects 225 that are assigned to a first version 253 of the textual intermediate representation 213 and textual program objects 225 that are assigned to a second version 255 of the textual intermediate representation 213. The two versions of the textual intermediate representation 213 describe two versions of the graphical diagram 211 and of the control program 209, respectively. The two versions were written at different times and/or by different authors during the programming process.

After receiving the textual conflict information 269, a conflict determining step 125 determines whether at least one textual program object 225 assigned to the first version 253 of the textual intermediate representation 213 and a textual program object 225 assigned to the second version 255 of the textual intermediate representation 213, which have an identical identity 243 but different definitions. Two textual program objects 225 have different definitions if the textual program objects 225 comprise different semantics, i.e., if the textual program objects 225 define different program-technical objects.

This may occur, for example, when different developers are programming independently on the same program code.

The conflict detecting step 125 comprises a conflict translating step 159. In the conflict translating step 159, the translation module 205 translates the textual conflict information 269 into graphical conflict information 271. The graphical conflict information 269 comprises the graphical program objects 217 corresponding to the textual program objects 225 of the textual conflict information 269.

In a conflict resolving step 161, the conflict is resolved. For this purpose, the at least one graphical program object 217 that corresponds to a textual program object 225 that is assigned to the first version 253 of the textual intermediate representation 213 and which comprises an identity 243 identical to a further graphical program object 217 corresponding to a textual program object 225 assigned to the second version 255 of the textual intermediate representation 213 is deleted.

The conflict resolution 200 may be carried out by the development environment or, alternatively, by a user.

In a textual displaying step 115, the at least one textual program object 225 of the textual difference information 235 is displayed in the textual editor unit 203.

For this purpose, in a characterizing step 121, the textual program object 225 of the textual difference information 235 and/or the graphical program object 217 of the graphical difference information 289, 291 is displayed as an added textual program object 261 or as an added graphical program object 265 or as a deleted textual program object 263 or as a deleted graphical program object 267.

In a difference translating step 117, the textual difference information 235 is translated into graphical difference information by translating the at least one textual program object 225 into a corresponding graphical program object 217.

In a graphical displaying step 119, the at least one graphical program object 217 of the graphical difference information 235 is displayed in the graphical editor unit 201 of the development environment 200.

For this purpose, in a characterizing step 121, the textual program object 225 of the textual difference information 235 and/or the graphical program object 217 of the graphical difference information 289, 291 is displayed as an added textual program object 261 or as an added graphical program object 265 or as a deleted textual program object 263 or as a deleted graphical program object 267.

The textual or graphical program objects may be characterized, for example, by coloring or hatching the respective program object 217, 225 within the graphical diagram 211 or within the textual intermediate representation 213.

In the textual intermediate representation 213, the added or deleted textual program objects 261, 263 may be displayed as corresponding added or deleted textual lines 241, optionally with corresponding graphical or color identification.

Similarly, the added or deleted graphical program objects 265, 267 may be represented within the graphical diagram 211 by the aforementioned graphical or color identifier, for example, as added or deleted node objects 249 and/or edge objects 251.

Subsequently, in a generating step 111, the control program 209 is generated based on the textual intermediate representation 213 and/or based on the graphical diagram 211.

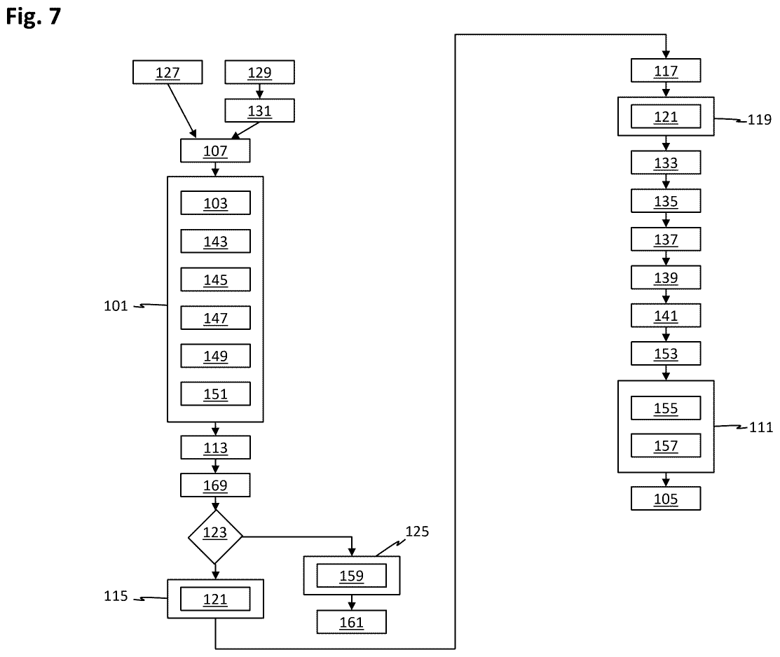

FIG. 7 shows a further flowchart of the method 100 for generating a control program 209 for an automation system according to a further embodiment.

The embodiment in FIG. 7 is based on the embodiment in FIG. 6 and comprises all the method steps described therein. Unless these have been changed, a detailed description is omitted.

The embodiment shown describes, among other things, two cases for providing the graphical diagram 211.

In one case, a program file 221 is read in by the development environment 200 in a reading step 129. A description of the graphical diagram 211 is stored in textual form in the program file 221.

In a second translating step 131, the textual information of the program file 221 is translated into the graphical diagram 211.

This describes the case in which a previously generated graphical diagram 211, which is temporarily stored in textual form in the program file 221, is generated by reading the information from the program file 221 by the development environment 200 in order to generate the graphical diagram 211. This covers the case where a graphical diagram 211 that has already been generated at an earlier point in time is loaded into the development environment 200 in order to be further processed or modified by carrying out corresponding programming operations.

In the second case, graphical input commands 215 from a user of the development environment 200 are first received by the graphical editor unit 201 in a graphical programming step 127. The graphical input commands 215 comprise programming commands for adding and/or removing graphical program objects 217. The graphical program objects 217 are sub-elements of the graphical diagram 211 and represent program objects 219 of the control program 209 to be generated.

This describes the case of a graphical programming operation. The graphical input commands 215 correspond to programming actions that are entered by the user during programming in accordance with the graphical programming language. The graphical programming process allows for an existing graphical diagram 211 displayed in the graphical editor unit 201 to be modified by adding or removing graphical program objects 217. As an alternative, a completely new graphical diagram 211 may be generated by carrying out the graphical programming process.

Furthermore, the first translating step 101 comprises a behavior determining step 143. In the behavior determining step 143, the graphical program objects 217 and a graphical behavior 233 of the graphical diagram 211 are determined. Furthermore, a behavior position 239 of the graphical behavior 233 of the graphical diagram 211 is determined.

The graphical behavior 233 is a graphical representation of a program sequence of the control program 209. The behavior position 239 of the graphical behavior 233 describes a position of the graphical diagram 211 within the corresponding program code comprising at least the graphical diagram 211.

In a behavior translating step 145, the graphical program objects 217 and the graphical behavior 233 are then translated into textual program objects 225 and a textual behavior 237 of the textual intermediate representation 213. The textual behavior 237 represents a textual representation of the program flow of the control program 209.

In an arranging step 147, the textual behavior 237 is then arranged within the textual intermediate representation 213 at the behavior position 239. The behavior position 239 defines the arrangement of the textual behavior 237 within the textual intermediate representation 213.

The individual textual program objects 225 represented as textual lines 241 may be arranged according to the integrated identities 243.

In an identity determining step 149, identities 243 of the graphical program objects 217 of the graphical diagram 211 are determined. The identities 243 allow for the respective graphical program objects 217 to be uniquely identified.

The determined identities 243 of the graphical program objects 217 are then integrated into the respective textual program objects 225 represented by the textual lines 241 in an integrating step 151. Conversely, the identities 243 of the textual program objects 225 may also be integrated into the graphical program objects 217.

In the embodiment shown, textual input commands 223 from the user are first received in a textual programming step 133 by the textual editor unit 203 of the development environment 200. The textual input commands 223 add textual program objects 225 to the textual intermediate representation 213 as textual representations of corresponding graphical program objects 217 of the graphical diagram 211 or remove them from it. The textual program objects 225 are textual representations of the graphical program objects 217 of the graphical diagram 211.

In a second generating step 135, a modified textual intermediate representation 227 is generated based on the textual input commands 223 and the textual intermediate representation 213.

In a third translating step 137, the modified textual intermediate representation 227 is then translated into a correspondingly modified graphical diagram 231. As an alternative or in addition, the textual modifications to the textual intermediate representation 213 caused by the textual input commands may be translated into graphical modifications to the graphical diagram 211. The textual modifications comprise at least one textual program object 225 that is newly added to the textual intermediate representation 213 or deleted from the textual intermediate representation 213. The graphical modifications translated from the textual modifications accordingly comprise at least one graphical program object 217 that is newly added to the graphical diagram 211 or deleted from the graphical diagram 211.

In a third displaying step 139, the modified textual intermediate representation 227 of the modified graphical diagram 231 is displayed in the textual editor unit 203.

In a fourth displaying step 141, the modified graphical diagram 231 is displayed in the graphical editor unit 201 instead of the graphical diagram 211.

As an alternative or in addition, the graphical modifications are displayed in the graphical diagram 211. For this purpose, the graphical diagram 211 in the graphical editor unit 210 is modified in accordance with the modifications by inserting the at least one newly added graphical program object 217 of the graphical modifications into the existing graphical diagram 211.

The newly added graphical program object 217 may be marked accordingly as a new graphical program object 217, for example by color.

Accordingly, the graphical program object 217 deleted from the graphical diagram 211 in accordance with the graphical modifications is marked accordingly, also by color, as the case may be.

Furthermore, in a summarizing step 153, the textual intermediate representation 213 of the graphical diagram 211 and at least one further intermediate representation of at least one further graphical diagram are combined to form a textual overall intermediate representation. In the overall intermediate representation, a plurality of different textual intermediate representations 213 of a plurality of different graphical diagrams 211 are thus combined into a coherent code in textual form.

The textual behaviors of the multiple textual intermediate representations 213 are arranged in the textual overall intermediate representation at the corresponding behavior positions.

Additional textual information is arranged between the textual behaviors 237 of the various graphical diagrams in the overall textual intermediate representation. The additional information may include, for example, data types, variable types, or other information. The additional information arranged in the overall intermediate representation between the behaviors of the various graphical diagrams may be written in a basic language predefined by the IEC 61131-3 standard.

The basic language describes the form in which the additional information must be written as specified by the standard.

The behavior of the various graphical diagrams, on the other hand, is written in a sublanguage with a syntax that corresponds to the syntax of the programming languages defined by the IEC 61131-3 standard: contact diagram, functional block language, or sequence language.

The sublanguage represents the aforementioned graphical programming languages in text form and is embodied in a form that is readable by the user.

In the textual overall intermediate representation, the basic language represents the framework of the coherent code, while the sublanguages are textual representations of the graphical diagrams, and in particular of the behavior of the graphical diagrams 211.

According to an embodiment, the textual intermediate representation 213, which only represents a graphical diagram 211, may also comprise a textual basic language predefined by the IEC 61131-3 standard, in which the additional information is provided with the basic conditions such as data types and/or variable types of the textual behavior 237 representing the graphical behavior 233. The corresponding textual behavior 237 is written in a sublanguage corresponding to one of the programming languages ladder logic, functional block language, or sequence language, as described above.

In the embodiment shown, the control program 209 is generated in the generating step 111 based on the modified textual intermediate representation 227 or based on the textual overall intermediate representation and/or based on the modified graphical diagram 231 or the plurality of modified graphical diagrams 231.

The embodiment shown describes the case in which the user carries out a textual programming operation based on the textual intermediate representation 213, resulting in a modification of the textual intermediate representation 213 and, based on this, a modification of the graphical diagram 211.

For this purpose, the user removes textual program objects 225 from the textual intermediate representation 213 in the form of textual input commands 223 or adds further textual program objects 247 to the textual intermediate representation 213. By modifying the textual intermediate representation 213 by the user by carrying out the textual programming operation, a correspondingly modified graphical diagram 231 may be generated after translating the modified textual intermediate representation 227 generated by carrying out the modification.

The user may thus advance the programming of the control program 209 based on the graphical programming language both by carrying out a graphical programming operation and by carrying out a textual programming operation.

Furthermore, the generating step 111 in the embodiment shown comprises a debugging step 155. In the debugging step 155, a debugging process of the control program 209 is carried out based on the textual intermediate representation 213 or based on the modified textual intermediate representation 227.

Furthermore, the generating step 111 comprises a binary code generating step 157. In the binary code generating step 157, a binary representation of the control program 209 is generated in order to generate the control program 209.

Although the invention has been further illustrated and described in detail by embodiments, the invention is not limited by the disclosed examples and other variations may be derived therefrom by those skilled in the art without departing from the protective scope of the invention.

TABLE 1
List of reference numerals 100-269

100 Method
101 First translating step
103 Line translating step
105 Storing step
107 First displaying step
109 Second displaying step
111 Generating step
113 Receiving step
115 Textual displaying step
117 Difference translating step
119 Graphical displaying step
121 Characterizing step
123 Conflict checking step
125 Conflict determining step
127 Graphical programming step
129 Reading step
131 Second translating step
133 Textual programming step
135 Second generating step
137 Third translating step
139 Third displaying step
141 Fourth displaying step
143 Behavior determining step
145 Behavior translating step
147 Arranging step
149 Identity determining step
151 Integrating step
153 Summarizing step
155 Debugging step
157 Binary code generating step
159 Conflict translating step
161 Conflict resolving step
200 Development environment
201 Graphical editor unit
203 Textual editor unit
205 Translation module
207 Version management system
209 Control program
211 Graphical diagram
213 Textual intermediate representation
215 Graphical input command
217 Graphical program object
219 Executable program object
221 Program file
223 Textual input command
225 Textual program object
227 Modified textual intermediate representation
229 Further graphical program object
231 Modified graphical diagram
233 Graphical behavior
235 Textual difference information
237 Textual behavior
239 Behavior position
241 Textual line
243 Identity
245 Representation file
247 Further textual program object
249 Node object
251 Edge object
253 First version of textual intermediate representation
255 Second version of textual intermediate representation
257 First version of the graphical diagram
259 Second version of the graphical diagram
261 Added textual program object
263 Deleted textual program object
265 Added graphical program object
267 Deleted graphical program object
269 Textual conflict information

TABLE 2
List of reference numerals 271-307; references ID1-ID8

271 Graphical conflict information
273 First node object
275 Second node object
277 Third node object
279 Fourth node object
281 Fifth node object
283 Edge object between first node object
and second node object
285 Edge object between first node object
and third node object
287 Edge object between third node object
and fifth node object
289 First graphical difference information
291 Second graphical difference information
293 First textual program object
295 Second textual program object
297 Third textual program object
299 Fourth textual program object
301 Fifth textual program object
303 Sixth textual program object
305 Seventh textual program object
307 Eighth textual program object
ID1 Identity of first textual program object
ID2 Identity of second textual program object
ID3 Identity of third textual program object
ID4 Identity of fourth textual program object
ID5 Identity of fifth textual program object
ID6 Identity of sixth textual program object
ID7 Identity of seventh textual program object
ID8 Identity of eighth textual program object

1. A computer implemented method for generating a control program for an automation system, comprising:
translating a graphical diagram of a graphical programming language into an intermediate textual representation of the graphical diagram with the aid of a translation module of a development environment in a first translating step,
wherein the graphical diagram is at least part of a control program for an automation system according to the graphical programming language, wherein the textual intermediate representation provides a textual description of the graphical diagram;
wherein the first translating step comprises:
carrying out a line-by-line translation in a line translating step, wherein, in the line-by-line translation, graphical program objects of the graphical diagram are each assigned a textual program object in the form of at least one textual line of the textual intermediate representation,
wherein the graphical program objects are partial elements of the graphical diagram and represent program objects of the control program, and wherein the textual lines of the textual program objects provide unique descriptions of the respective graphical program objects; and
storing the textual intermediate representation in a representation file in a storing step.

2. The method according to claim 1, further comprising:
displaying the graphical diagram in a graphical editor unit of the development environment in a first displaying step,
and/or
displaying the textual intermediate representation of the graphical diagram in a textual editor unit of the development environment in a second displaying step; and
generating the control program based on the textual intermediate representation of the graphical diagram of the graphical programming language and/or based on the graphical diagram in a generating step.

3. The method according to claim 1, further comprising:
receiving a textual difference information from a version management system via the development environment in a receiving step,
wherein the textual difference information describes a difference between a first version of the textual intermediate representation and a second version of the textual intermediate representation,
wherein the first version and the second version of the textual intermediate representation are each representations of a first version and of a second version of the graphical diagram, wherein the first and second versions of the graphical diagram were created in a programming process based on each other or based on a common base diagram, and
wherein the textual difference information defines at least one textual program object that is contained only in one of the two versions of the textual intermediate representation; and
displaying the at least one textual program object of the textual difference information in the textual editor unit of the development environment in a textual displaying step, and/or
translating the textual difference information into graphical difference information by translating the at least one textual program object into a corresponding graphical program object in a difference translating step; and
displaying the at least one graphical program object of the graphical difference information in the graphical editor unit of the development environment in a graphical displaying step.

4. The method according to claim 1, wherein:
the second version of the graphical diagram comprises a later generation date than the first version of the graphical diagram,
wherein, in the corresponding second version of the textual intermediate representation, at least one textual program object is added or removed compared to the first version of the textual intermediate representation, and
wherein, in the textual difference information, the at least one textual program object is identified as a textual program object added to or deleted from the first version of the textual intermediate representation.

5. The method according to claim 4, wherein the textual displaying step and/or the graphical displaying step comprises characterizing the textual program object of the textual difference information and/or the graphical program object of the graphical difference information as an added textual program object or as an added graphical program object or as a deleted textual program object or as a deleted graphical program object in a characterizing step.

6. The method according to claim 3, wherein:
a textual program object changed from the first version of the textual intermediate representation to the second version of the textual intermediate representation is stored in the difference information as a pair consisting of a deleted textual program object of the first version of the textual intermediate representation and an added textual program object of the second version of the textual intermediate representation, and
wherein the deleted textual program object represents an original version of the modified textual program object and the added textual program object represents a modified version of the modified textual program object.

7. The method according to claim 6, wherein the deleted graphical program object corresponding to the deleted textual program object and/or the added graphical program object corresponding to the added textual program object and/or a modified graphical program object corresponding to the modified textual program object are represented in the graphical diagram as a deleted graphical program object and/or as an added graphical program object and/or as a modified graphical program object.

8. The method according to claim 3, further comprising:
receiving textual conflict information from the version management system and carrying out a conflict check between the first version of the textual intermediate representation and the second version of the textual intermediate representation in a conflict checking step,
wherein the textual conflict information comprises textual program objects associated with the first version of the textual intermediate representation and comprises textual program objects associated with the second version of the textual intermediate representation; and
determining a conflict in a conflict determining step if at least one textual program object assigned to the first version of the textual intermediate representation and at least one textual program object assigned to the second version of the textual intermediate representation are identified, which have the same identity and are modified relative to one another.

9. The method according to claim 8, wherein the conflict determining step comprises:
translating the textual conflict information into graphical conflict information with the aid of the translation module in a conflict translating step,
wherein the graphical conflict information comprises graphical program objects corresponding to the textual program objects of the textual conflict information; and
resolving the conflict by deleting the at least one graphical program object that corresponds to a textual program object that is assigned to the first version of the textual intermediate representation and that comprises the same identity as a further graphical program object corresponding to a textual program object associated with the second version of the textual intermediate representation, in a conflict resolving step.

10. The method according to claim 1, further comprising:
receiving graphical input commands from a user of the development environment via a graphical editor unit of the development environment in a graphical programming step, wherein the graphical input commands comprise programming commands for adding and/or removing graphical program objects of the graphical diagram; and/or
reading in a program file in a reading step, wherein the program file describes the graphical diagram and the graphical program objects of the graphical diagram in a textual description; and
translating the textual description into the graphical diagram by the translation module in a second translating step.

11. The method according to claim 1, further comprising:
receiving textual input commands from the user via by the textual editor unit of the development environment in a textual programming step, wherein the textual input commands add textual program objects as textual representations of corresponding graphical program objects of the graphical diagram to the textual intermediate representation of the graphical diagram or remove them therefrom;
generating a modified textual intermediate representation based on the textual input commands and the textual intermediate representation of the graphical diagram in a second generating step;
translating the modified textual intermediate representation into a correspondingly modified graphical diagram and/or translating the textual program objects of the textual input commands into corresponding graphical program objects by the translation module in a third translating step;
displaying the modified graphical diagram of the graphical diagram instead of the graphical diagram and/or displaying the graphical program objects translated from the textual program objects of the textual input commands in the graphical diagram as a modified graphical diagram in the graphical editor unit in a third displaying step;
generating the control program based on the modified textual intermediate representation of the modified graphical diagram and/or based on the modified graphical diagram in the generating step; and
displaying the modified textual intermediate representation of the modified graphical diagram in the textual editor unit in a fourth displaying step.

12. The method according to claim 1, wherein the first translating step further comprises:
determining the graphical program objects, a graphical behavior of the graphical diagram and at least one behavior position in a behavior determining step, wherein the graphical behavior is a graphical representation of a program sequence of the control program, and wherein the behavior position defines a position predefined by an IEC 61131-3 standard in a program code at which a behavior of a control program is to be positioned;
translating the graphical program objects and the graphical behavior of the graphical diagram into textual program objects and a textual behavior of the textual intermediate representation in a behavior translating step, wherein the textual behavior represents a textual intermediate representation of the execution of the control program; and
arranging the textual behavior at the behavior position within the textual intermediate representation in an arranging step.

13. The method according to claim 1, wherein the first translating step further comprises:
determining identities of the graphical program objects of the graphical diagram in an identity determining step, wherein the identities of the graphical program objects allow for unique identification of the respective graphical program objects; and
integrating the identities of the graphical program objects into the respective graphical program objects assigned to the graphical program objects and into textual program objects of the textual intermediate representation written in textual lines in an integrating step.

14. The method according to claim 13, wherein for linked graphical program objects, the identities of the linked graphical program objects are integrated into the corresponding textual program objects.

15. The method according to claim 1, wherein the graphical program objects comprise graphically representable meta-information, and wherein the meta-information comprises at least one of the following: author, creation date, version of the graphical diagram.

16. The method according to claim 1, further comprising:
combining the textual intermediate representation of the graphical diagram with at least one further intermediate representation of at least one further graphical diagram to form a textual overall intermediate representation in a summarizing step,
wherein the overall intermediate representation combines a plurality of different textual intermediate representations of a plurality of different graphical diagrams into a coherent code in textual form.

17. The method according to claim 1, wherein the generating step comprises:
carrying out a debugging process based on the textual intermediate representation of the graphical diagram in a debugging step; and/or
generating a binary representation of the control program in a binary code generating step.

18. The method according to claim 1, wherein the graphical programming language is one of the following: contact plan, functional block language, sequence language.

19. The method according to claim 1, wherein a syntax of the textual intermediate representation and of the modified textual intermediate representation is conflict free with regard to a syntax of the graphical programming language.

20. A development environment having a graphical editor unit, a textual editor unit and a translation module, wherein the development environment is set up to carry out the method according to claim 1.
